(19) United States
(12) Patent Application Publication
(10) Pub. No.: US 2009/0060366 A1
(43) Pub. Date: Mar. 5, 2009

(54) OBJECT SEGMENTATION IN IMAGES

(75) Inventors: Steve W. Worrell, Beavercreek, OH (US); Peter Maton, Miamisburg, OH (US); Praveen Kakumanu, Miamisburg, OH (US); Tripti Shastri, Miamisburg, OH (US); Richard V. Burns, Beavercreek, OH (US)

Correspondence Address: CONNOLLY BOVE LODGE & HUTZ LLP, 1875 EYE STREET, N.W., SUITE 1100, WASHINGTON, DC, 20006, US

(73) Assignee: RIVERAIN MEDICAL GROUP, LLC, Miamisburg, OH (US)

(21) Appl. No.: 11/926,432

(22) Filed: Oct. 29, 2007

Related U.S. Application Data
(60) Provisional application No. 60/968,139, filed on Aug. 27, 2007.

(51) Int. Cl. G06K 9/42

(52) U.S. Cl. 382/256

(57) ABSTRACT

Embodiments of the invention may process an input image using phase symmetry methods and use the resulting processing results to determine an object in the image. The object may be suppressed, if desired.

### CROSS-REFERENCE TO RELATED APPLICATION

This application claims the priority of U.S. Provisional Patent Application No. 60/968,1139, filed on Aug. 27, 2007, and incorporated by reference herein.

### FIELD OF ENDEAVOR

Various embodiments of the invention may relate, generally, to the segmentation of objects from images. Further specific embodiments of the invention may relate to the segmentation of bone portions of radiological images.

### BACKGROUND

Computer-aided detection (CAD) solutions for chest images may often suffer from poor specificity. This may be in part due to the presence of bones in the image and lack of spatial reasoning. False positives (FPs) may arise from areas in the chest image where one rib crosses another or crosses another linear feature. Similarly, the clavicle crossing with ribs may be another source of FPs. If the ribs and the clavicle bones are subtracted from the image, it may be possible to reduce the rate of FPs and to increase the sensitivity, via the elimination of interfering structures. Due to the domination of the lung area by the ribs, the probability of a nodule being at least partially overlaid by a rib is high. The profile of the nodule may thus be modified by an overlaying rib, which may make it more difficult to find. Subtracting the rib may result in a far clearer view of the nodule, which may permit a CAD algorithm to more easily find it and reason about it.

The ability to reason spatially may also be a consideration in chest CAD. Delineation of rib and clavicle boundaries may provide important landmarks for spatial reasoning. For example, knowledge of the clavicle boundaries may allow a central line (i.e., spine or mid-line between the two boundaries) of the clavicle to be determined. The clavicle “spine” may be used to provide a reference line or reference point at the intersection point with the rib cage. Similarly, knowledge of the rib boundaries may allow a rib spine to be determined. Knowledge of the rib number along with the rib spine and intersection point with the rib cage may be used to provide a patient-specific point of reference.

Several attempts have been made to, solve the rib segmentation problem. Considering the rib and clavicle subtraction problem, the approach by Kenji Suzuki at University of Chicago may be the most advanced. However, this has been achieved in an academic environment where tuning of the algorithm parameters can be made to fit the characteristics of the sample set. The particular method is based on a direct pixel-driven linear artificial neural net that calculates a subtraction value for each pixel in the image based on the degree of bone density detected by the network. The result can be noisy, and an exemplary implementation only worked for bones near to horizontal in the image.

Various other researchers have anecdotally illustrated techniques for rib segmentation in the open literature. However, in all cases known to the inventors, researchers have noted that the techniques suffer from brittleness, and as a consequence, rib segmentation remains an open area of research. No such applications have yet met the level of performances required for clinical application.

Although clavicle segmentation has been mentioned as potentially useful, no solutions have been proposed.

### BRIEF DESCRIPTIONS OF THE DRAWINGS

Various embodiments of the invention will now be described in conjunction with the attached drawings, in which:

FIG. 1 depicts a flow charts of an embodiment of the invention;

FIG. 2 depicts another flowchart that may correspond to various embodiments of the invention;

FIGS. 3A and 3B show images prior to and during processing according to an embodiment of the invention;

FIGS. 4A-4D show images that may be associated with various portions of processing according, to various embodiments of the invention;

FIGS. 5A and 5B show further images that may correspond to various portions of processing according to various embodiments of the invention;

FIGS. 6A and 6B show further images that may correspond to various portions of processing according to various embodiments of the invention; and

FIG. 7 depicts a conceptual block diagram of a system in which at least a portion of an embodiment of the invention may be implemented.

### DETAILED DESCRIPTION OF VARIOUS EMBODIMENTS

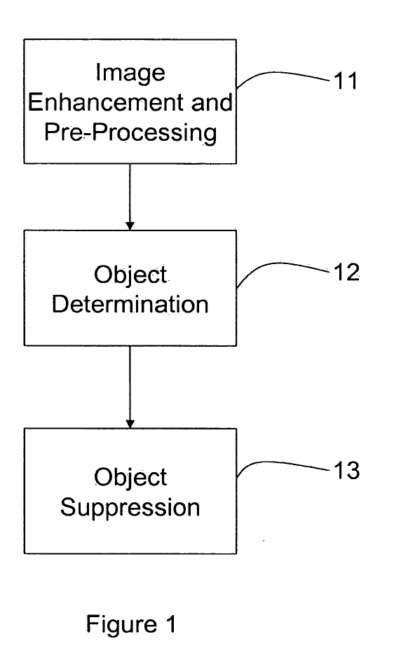

FIG. 1 shows an overview of an embodiment of the invention. An image may be input and may undergo enhancement and/or other pre-processing 11. The image thus processed may then undergo object determination 12. In this portion, structures, such as ribs and/or clavicles, may be identified and segmented. Outputs may include, for example, parameters that identify size and/or location of such objects in the image. The outputs may then, if desired, be fed to a process to suppress the determined object(s) 13 from the images. In an exemplary embodiment of the invention, the images may be radiological images (such as, but not limited to, X-rays, CT scans, MRI images, etc.), and the structures may correspond to ribs, clavicles, and/or other bone structures or anatomical structures.

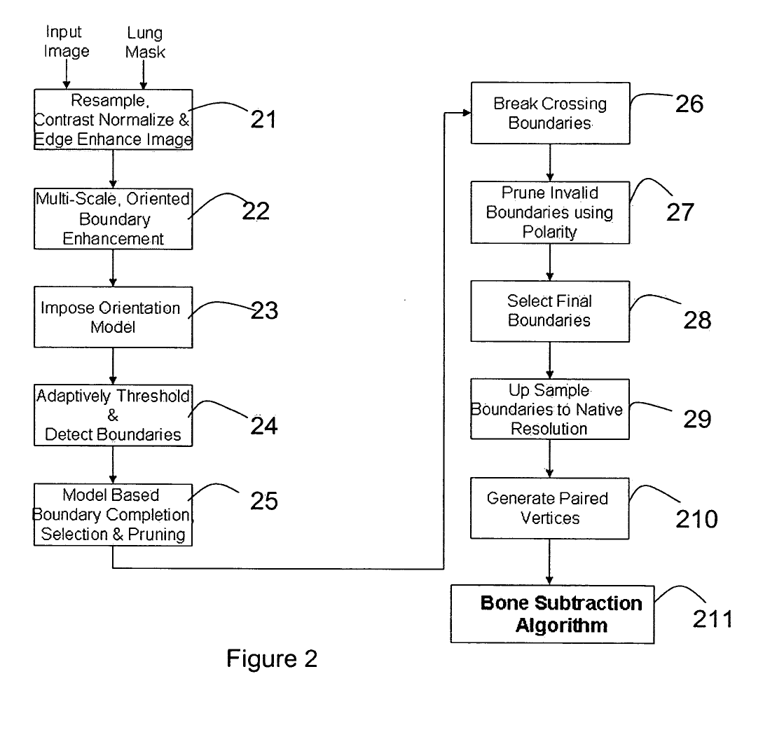

FIG. 2 provides a mote detailed flowchart that may relate to that shown in FIG. 1, for some embodiments of the invention. Image enhancement/pre-processing 11 may, roughly speaking, correspond to blocks 21-23 of FIG. 2.

As shown in block 2l, an input image may be operated on by various methods to form an image that is normalized with respect to contrast and pixel spacing. Initially all image data may be re-sampled to form a fixed inter-pixel spacing; in some exemplary implementations, this re-sampling may be to 0.7 mm inter-pixel spacing, but the invention is not thus limited. The fixed inter-pixel spacing, may permit subsequent image processing algorithms to employ known optimal kernel scales. To achieve consistent contrast properties across different acquisition systems and acquisition parameters, local contrast enhancement operators may be applied to minimize the effects of global and local biases that may exist in, native image data. Additionally, edge detail may be enhanced (i.e., edge enhancement), which may serve to aid subsequent processes aimed at detecting interfaces, e.g., tissue/air and bone interfaces.

In block 22, a phase symmetry estimate may be computed from the re-sampled, contrast normalized, and edge enhanced image. In a chest image, the phase symmetry image may provide the basis for clavicle and/or rib segmentation. Phase symmetry may generally involve the determination of image features based on determining consistency of pixels across line segments oriented at different angles. Phase symmetry may be used to provide a normalized response from 0 to 1, where one may indicate complete bilateral symmetry for a particular considered scale and orientation. Orientation may provide prior knowledge regarding the orientation of ribs and clavicles and may allow unwanted structures to be suppressed. In addition to employing multi-scale, oriented kernels for selective enhancement, an adaptive noise model may be used to suppress irrelevant responses arising from noise and small-scale structures, such as quasi-linear vessels in the chest.

As shown in block 23, an orientation model may be applied to the output of block 22. Phase symmetry may be helpful in providing both the amplitude and the orientation corresponding to the maximum response. The availability of an orientation estimate may allow a priori orientation models associated with the objects of interest, clavicles and/or ribs, to be exploited. This capability may be exploited to suppress responses that can be attributed to linear structures whose orientation is not consistent with prior models of valid clavicle and rib orientations. In particular, images may be filtered based on orientation to eliminate or attenuate objects that are incorrectly oriented. It is noted that in the case of chest images, one may take advantage of the fact that the orientation models for the left and right lungs are substantial complements of each other.

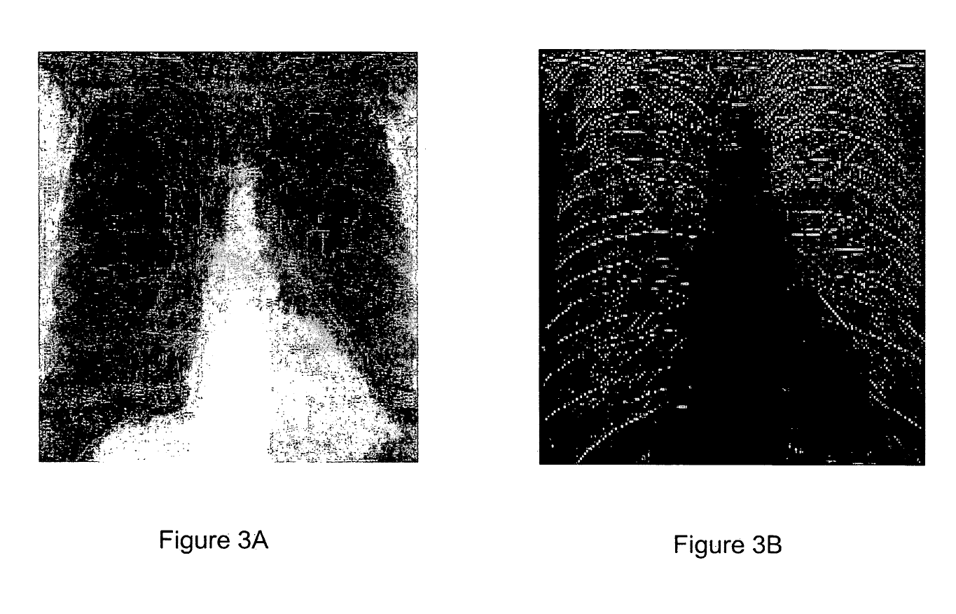

To further illustrate how embodiments of blocks 21-23 may operate, some exemplary results will now be presented. FIGS. 3A and 3B show a raw chest image and an associated phase symmetry image, respectively. As shown, the phase symmetry image may enhance both the clavicle and rib boundaries.

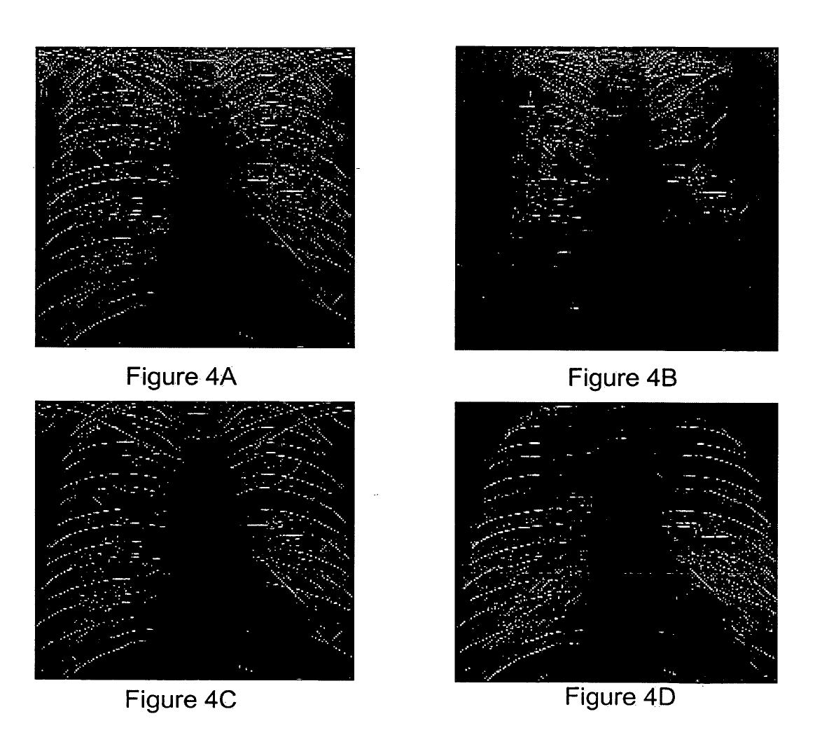

FIGS. 4A-4D illustrate how phase symmetry and orientation filtering may be used to enhance images and better-define structures. Phase symmetry may provide both a magnitude and an orientation response. The orientation image may provide a powerful means of filtering undesirable responses, such as those due to linear structures. FIGS. 4A and 4C show an original phase symmetry image. FIGS. 4B and 4D show corresponding exemplary orientation, filtered images. The first pair (FIGS. 4A and 4B) demonstrate an original and an orientation filtered image to support clavicle suppression. The second pair (FIGS. 4C and 4D) demonstrate an original and an orientation filtered image to support rib suppression.

Blocks 24-210 of FIG. 2 may roughly correspond to block 12 of FIG. 1, in some embodiments of the invention. In block 24, initial estimates of clavicle and rib boundaries may be formed using an edge masking process with an adaptive threshold, which may be implemented, for example, as follows:

T1=med(phase-image(find(label_mask˜=0)))+edge_threshold *mad;(phase_image(find(label_mask˜=0)));

edge_mask=hysthresh(phase image, T1, T1/3);

where;
edge_threshold is defined a priori,
med is the median of the valid region of the phase symmetry image (i.e., the response is constrained to only consider pixels inside the lung region; this may use a, lung mask, which may be an input, as shown in FIG. 2),
T1 is the adaptive threshold based on the phase symmetry image content,
hysthresh implements a two-parameter binary detection process, whereby the initial threshold (T1) is used to identify prominent edges (high contrast) and the second threshold (T1/3) allows edges connected to the higher contrast edges to be linked to the high contrast edges associated with the threshold T1, and mad is the mean absolute difference (note that this may provide a robust estimate of the standard, deviation of the image).

A common issue associated with edge detection processes is the fragmentation of continuous boundaries due to noise and superposition. Although the two-stage threshold defined above may greatly reduce fragmentation, it may not, fully eliminate it. To further reduce fragmentation, edge linking may be employed. Implementation of such edge linking may involve linking the tail and head (or head and tail) of two edges if they are sufficiently close and have consistent orientations to within a specified tolerance.

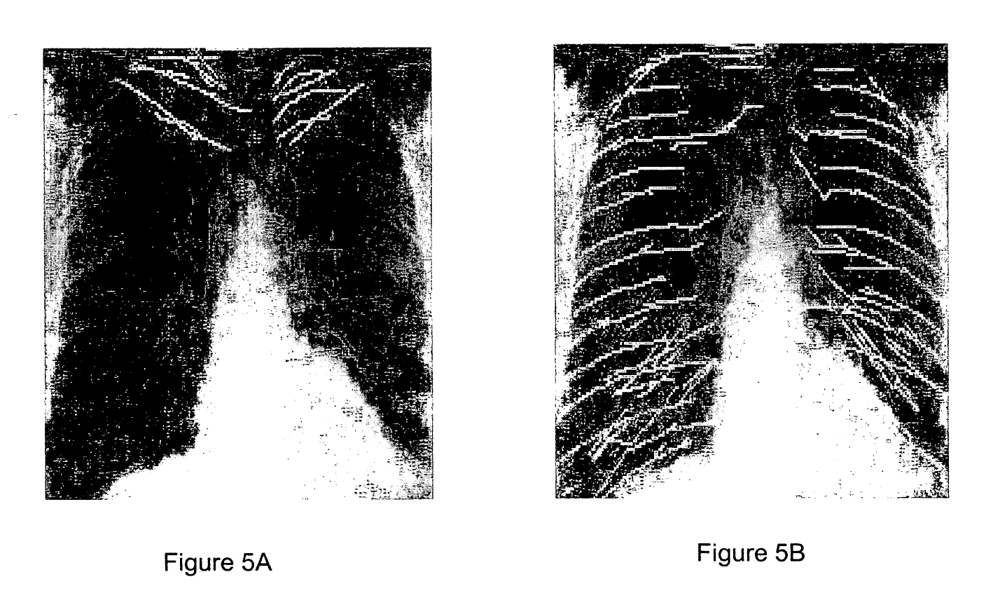

In an example, FIGS. 5A and 5B show, respectively, the clavicle and rib edges that may be obtained. Note that prior positional knowledge may be used in clavicle detection, in addition to the orientation field. In particular, only the upper region of the lung and those edges connected to the lung outer boundary may need to be considered for further processing. FIG. 5A shows the clavicle boundary candidates (edges), while FIG. 5B shows the rib boundary candidates (edges). Note that, in both cases, various issues may exist, which may include spurious edge responses (edge structures associated with structures other than the clavicle and rib boundaries), broken or non-connected edges, and/or invalid edge trajectories due to overlapping structures on what is otherwise a valid edge.

Following the identification of edge objects, generated through the edge thresholding and linking process 24, block 25 may be used to construct object edge models. In one embodiment of block 25, a non-linear least-squares process may be employed to fit an a priori polynomial model to each candidate edge object. Using the extracted polynomial model, the edge may be extrapolated. This may serve to fill gaps and to project edges across the full extent of the lung (in a chest image). In some embodiments, to avoid poorly behaved models, only, those edge objects with adequate normalized extent, which may be defined as object_width/lung_width, may be considered in the fitting process. Furthermore, edge objects at the extreme top or bottom portion of the lung may be, excluded, from consideration, as these regions may be outside the regions of interest for detecting ribs or clavicles. This may be particularly useful for clavicle segmentation, where only the upper third portion of the lung may need to be considered. In the event that estimated coefficients are inconsistent with the a priori model, the edge objects may be considered invalid and may be removed. In those instances when the coefficients are consistent with the prior model, the fitted model may be retained and considered a valid candidate object (e.g., rib or clavicle) border.

A subsequent process that may be used to enhance sensitivity is adaptive correlation of extracted rib models. For a variety of reasons, all boundaries of ribs may not always be detected. Rib boundaries may not be detected, for example, due to fragmentation, poorly behaved modeling of the edges, etc. To improve sensitivity, a two-stage process may be employed. First, an attempt may be made to extract and model the edge directly, as described above. Second, for each patient and each lung, one may select the “best” rib boundary model by computing a suitable error between, the extracted edge and modeled edge. Using the extracted boundary, model, a correlation may be applied. In an exemplary embodiment of the invention, that may be useful in rib and clavicle segmentation, this may be done in the vertical direction across all remaining edge objects. For those vertical positions that generate a sufficiently high correlation, the model may be used, e.g., as a rib boundary location.

The results of block 25 may then be processed in block 26. In chest images, for example, due to the steep and rapid convergence of individual ribs along the rib cage, fitted and/or extrapolated rib boundaries may intersect. This intersection may serve to complicate subsequent processing because the intersection of two rib boundaries may lead to improper labeling. Two rib or clavicle boundaries that intersect may be incorrectly treated as a single object rather than as the upper and lower boundary of a rib or clavicle object. To circumvent this issue, boundary candidates may be analyzed from the center toward the edges of the lung. In the event that two boundary objects that were separated at the center but subsequently intersected, at a point to the left or right of the center, the objects may be assumed to be the upper and lower boundary of a rib. The intersection point may be assumed to be an artifact of the extrapolation process. Therefore, the merged boundaries may be broken apart from the intersection point.

In block 27, invalid boundaries may be pruned. In the case of a chest image, it may be the case that the top-most clavicle and rib boundary should be positive contrast while the bottom-most clavicle and rib boundary should be negative contrast. Erroneous boundaries may be pruned as a precursor to pairing boundaries. After all boundary candidates are selected, the polarity of the edge response may be used to further prune invalid edge objects. Beginning with the top-most extracted boundary, objects may be sequentially removed until a positive contrast boundary is detected. Similarly, as noted above, the last detected boundary should possess a negative contrast. Therefore, beginning with the last extracted boundary, objects may be sequentially removed until a negative contrast boundary is detected. This process may be employed separately for both lung objects and independently when detecting clavicle and rib objects.

Following boundary pruning 27, final boundaries may be selected 28. In block 28, the distances with respect to paired positive and negative contrast edges may be considered. For example, in a chest image, to be considered a valid rib or clavicle boundary pair, two adjacent boundaries may typically have opposite contrast and be separated by a minimum vertical distance (d₁) and separated by no more than a maximum vertical distance (d₂). Boundary objects not paired with an opposite contrast and a specified distance apart may thus be removed.

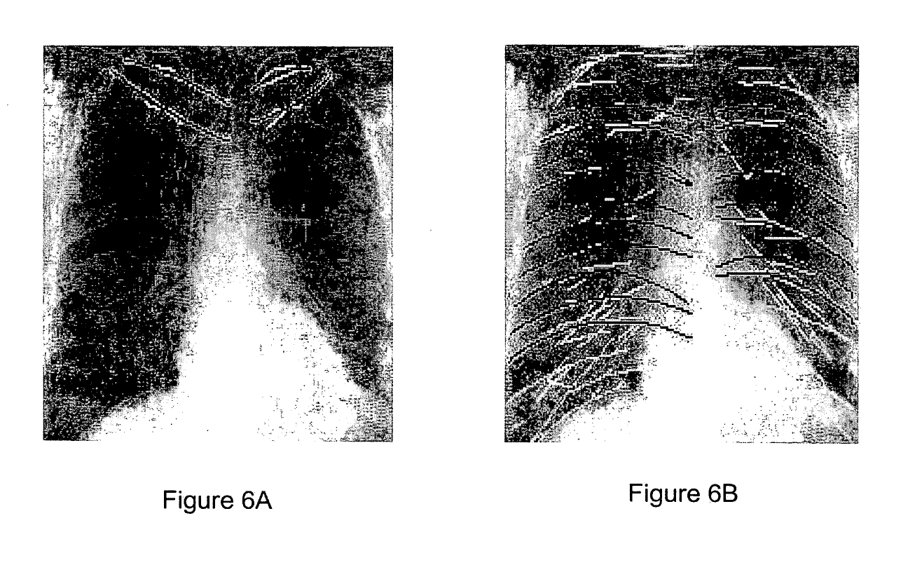

In an example corresponding to the example shown in FIGS. 5A and 5B, FIGS. 6A and 6B show results that may be obtained following processing in blocks 25-28. The originally-determined candidate edges, shown in FIGS. 5A and 5B, are shown again as light lines in FIGS. 6A and 6B. The resulting edges, after the processing in blocks 25-28, are shown as dark lines in FIGS. 6A and 6B.

In order to reconcile the modeled boundaries with the original image, one may need to up-sample the boundaries 29. This may thus form a fall-resolution map of the desired boundaries.

Finally, in some embodiments, it may be desirable to obtain paired vertices that may be used to define objects. In such cases, block 210 may be used to obtain such paired vertices based on the full-resolution boundary delimiters.

If desired, the results may then be used to suppress one or more segmented objects. For example, block 210 may correspond to a bone suppression process, which may be used, e.g., in the case of chest images, to subtract ribs and/or clavicles from the images.

While the illustrations have shown the use of the disclosed techniques in connection with the subtraction of ribs from chest images, such techniques may also be applied to other radiological images in which bone may interfere with observation of soft tissue phenomena. Furthermore, such techniques may also be applicable to non-radiological images in which known structures, which may be similar to bones in radiographic images, may be subtracted.

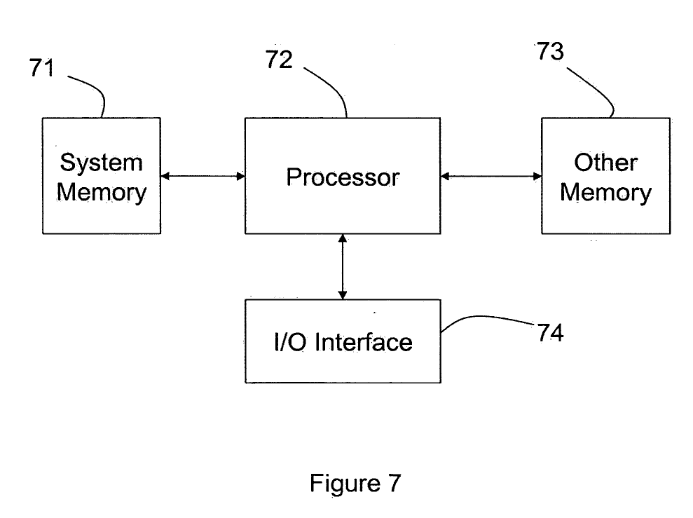

Various embodiments of the invention may comprise hardware, software, and/or firmware. FIG. 7 shows an exemplary system that may be used to implement various forms and/or portions of embodiments of the invention. Such a computing system may include one or more processors 72, which may be coupled to one or more system memories 71. Such system memory 71 may include, for example, RAM, ROM, or other such machine-readable-media, and system memory 71 may be used to incorporate, for example, a basic I/O system (BIOS), operating system, instructions for execution by processor 72, etc. The system may also include further memory 73, such as additional RAM, ROM, hard disk drives, or other processor-readable media. Processor 72 may also be coupled to at least one input/output (I/O) interface 74. I/O interface 74 may include one or more user interfaces, as well as readers for various types of storage media and/or connections to one or more communication networks (e.g., communication interfaces and/or modems), from which, for example, software code may be obtained.

Various embodiments of the invention have been presented above. However, the invention is not intended to be limited to the specific embodiments presented, which have been presented for purposes of illustration. Rather, the invention extends to functional equivalents as would be within the scope, of the appended claims. Those skilled in the art, having the benefit of the teachings of this specification, may make numerous modifications without departing from the scope and spirit of the invention in its various aspects.

We claim:

1. A method of processing an image, comprising:
computing phase symmetry of the image; and
determining at least one object in the image based on the phase symmetry.

2. The method according to claim 1, further comprising:
pre-processing the image prior to computing phase symmetry, wherein said pre-processing comprises at least one operation selected from the group consisting of: re-sampling the image, contrast enhancement, and gradient-based enhancement.

3. The method according to claim 1, further comprising:
applying orientation-based filtering to suppress an incorrectly oriented structure prior to determining at least one object.

4. The method according to claim 1, wherein said determining at least one object comprises:
performing edge masking with an adaptive threshold to obtain a boundary estimate of an object.

5. The method according to claim 4, said determining at least one object further comprising:
linking edges of boundary estimates in proximity to each other, and which are consistent in orientation to within a specified tolerance.

6. The method according to claim 4, wherein said determining at least one object further comprises:
constructing at least one object edge model based on said boundary estimate of the object.

7. The method according to claim 6, wherein said constructing comprises:
applying a non-linear least squares polynomial curve-fitting process.

8. The method according to claim 6, wherein said determining at least one object further comprises:
applying a correlation between an extracted edge and an edge model.

9. The method according to claim 4, wherein said determining at least one object further comprises:
breaking apart a spurious intersection of object boundaries.

10. The method according to claim 4, wherein said determining at least one object further comprises:
removing a spurious boundary.

11. The method according to claim 4, wherein said determining at least one object further comprises:
selecting final object boundaries based on at least one known characteristic of a desired object; and
determining paired vertices to define an object.

12. The method according to claim 1, further comprising:
downloading software code that, when executed by a processor, causes the processor to implement said computing phase symmetry and said determining at least one object.

13. A machine-readable medium containing, machine-executable instructions that, when executed, cause a machine to implement a method of processing an image, the method comprising:
computing phase symmetry of the image; and
determining at least one object in the image based on the phase symmetry.

14. The medium according to claim 13, wherein the method further comprises:
pre-processing the image prior to computing phase symmetry, wherein said pre-processing comprises at least one operation selected from the group consisting of: re-sampling the image, contract enhancement, and gradient-based enhancement.

15. The medium according to claim 14, wherein said pre-processing comprises re-sampling the image, and wherein the method further comprises:
re-sampling a resulting determined object to provide consistency with sampling characteristics of the original image.

16. The medium according to claim 13, wherein the method further comprises:
applying orientation-based filtering to suppress an incorrectly oriented structure prior to determining at least one object.

17. The medium according to claim 13, wherein said determining at least one object comprises:
performing edge masking with an adaptive threshold to obtain a boundary estimate of an object.

18. The medium according to claim 17, said determining at least one object further comprising:
linking edges of boundary estimates in proximity to each other, and which are consistent in orientation to within a specified tolerance.

19. The medium according to claim 17, wherein said determining at least one object further comprises:
constructing at least one object edge model based on said boundary estimate of the object.

20. The medium according to claim 19, wherein said constructing comprises:
applying a non-linear least squares polynomial curve-fitting process.

21. The medium according to claim 19, wherein said determining at least one object further comprises:
applying a correlation between an extracted edge and an edge model.

22. The medium according to claim 17, wherein said determining at least one object further comprises:
breaking apart a spurious intersection of object boundaries.

23. The medium according to claim 17, wherein said determining at least one object further comprises:
removing a spurious boundary.

24. The medium according to claim 17, wherein said determining at least one object further comprises:
selecting final object boundaries based on at least one known characteristic of a desired object.

25. The medium according to claim 13, wherein said determining at least one object comprises:
processing only a portion of the image believed a priori to contain a desired object.

26. The medium according to claim 13, wherein said determining at least one object comprises:
determining paired vertices to define an object.

27. The medium according to claim 13, wherein the method further comprises:
suppressing at least one determined object from the image.
